(19) United States
(12) Patent Application Publication
(10) Pub. No.: US 2016/0295001 A1
(43) Pub. Date: Oct. 6, 2016

(54) VEHICLE NETWORK SYSTEM AND PROTOCOL COMMUNICATION METHOD THEREFOR

(71) Applicant: Electronics and Telecommunications Research Institute, Daejeon (KR)

(72) Inventors: Doo Seop YUN, Daejeon (KR); Do Hyun KIM, Daejeon (KR); Young Jin KWON, Cheongju-Si (KR); Seung Jun LEE, Daejeon (KR)

(73) Assignee: Electronics and Telecommunications Research Institute, Daejeon (KR)

(21) Appl. No.: 14/961,880

(22) Filed: Dec. 7, 2015

(30) Foreign Application Priority Data
Mar. 31, 2015 (KR) 10-2015-0045386

(51) Int. Cl. H04M 1/725; H04B 1/3822; H04W 4/00

(52) U.S. Cl. CPC H04M 1/72527; H04W 4/005; H04B 1/3822

(57) ABSTRACT

Provided herein is a protocol communication method between a user terminal and the base station of a vehicle network system so as to easily provide a driver with pieces of information provided by an in-vehicle wireless sensor network system via the user terminal. A protocol communication method for a vehicle network system according to a first embodiment includes receiving, by the base station, a command message from the user terminal, receiving, by the base station, information responding to the command message from one or more vehicle wireless sensor nodes and/or an in-vehicle wired network, and sending, by the base station, a state message to the user terminal, based on the received information.

### CROSS-REFERENCE TO RELATED APPLICATION

The present application claims priority to Korean patent application number 10-2015-0045386 filed on Mar. 31, 2015, the entire disclosure of which is incorporated herein in its entirety by reference.

### BACKGROUND

1. Field of Invention

Various embodiments of the present disclosure relate to a protocol communication method for a vehicle network system, and more particularly, to a protocol communication method and apparatus between a user terminal and the base station of a vehicle network system that utilize a wireless sensor network.

2. Description of Related Art

Recently, vehicles have gradually evolved into intelligent vehicles, and the weights of vehicles have gradually increased due to an increase in wiring harness between an in-vehicle sensor and an Electronic Control Unit (ECU) and between ECUs. Due thereto, the production cost and failure rate of vehicles have increased, which deteriorate fuel efficiency. A large number of domestic/foreign enterprises related to vehicles have made a lot of effort to reduce the weights of vehicles. One of various technologies for reducing the weights of vehicles is to apply wireless network technology to an in-vehicle system.

In addition, as the number of users who use user terminals such as mobile and navigation devices has rapidly increased, a current service has moved based on user terminal services, so that a large number of application services that utilize user terminals have released, and application services related to vehicles have also gradually increased.

Accordingly, there is required a method for protocol communication between a user terminal and the base station that is the component of an in-vehicle wireless sensor network system that is the system using a wireless sensor network, in order to provide a driver with pieces of information provided by the in-vehicle wireless sensor network system.

### SUMMARY

Various embodiments of the present disclosure are directed to a protocol communication method between a user terminal and the base station of a vehicle network system so as to easily provide a driver with pieces of information provided by an in-vehicle wireless sensor network system via the user terminal.

A first embodiment of the present disclosure provides a protocol communication method for a vehicle network system, including receiving, by a base station, a command message from a user terminal; receiving, by the base station, information responding to the command message from one or more vehicle wireless sensor nodes and/or an in-vehicle wired network; and sending, by the base station, a state message to the user terminal, based on the received information.

A second embodiment of the present disclosure provides a protocol communication method for a vehicle network system, including receiving, by a base station, a command message from a user terminal; receiving, by the base station, information responding to the command message from one or more vehicle wireless sensor nodes and/or an in-vehicle wired network; and sending, by the base station, a data message to the user terminal, based on the received information.

In the first or second embodiment, the command message and the state message may include in common a control field and a data field, and the control field may include a message type sub-field and a control type sub-field.

The command message may be configured such that the message type sub-field of the control field is fixed at a first value, and a type of command is determined depending on a value of the control type sub-field.

The state message may be configured such that the message type sub-field of the control field is fixed at a second value, and the data field includes state information of the one or more wireless sensor nodes and/or state information of the wired network.

The data message may be configured such that the message type sub-field of the control field is fixed at a third value, and the data field includes sensor information of the one or more wireless sensor nodes and/or vehicle information.

A third embodiment of the present disclosure provides a vehicle network system, including one or more wireless sensor nodes installed inside and/or outside of a vehicle; a wired network installed inside of the vehicle; and a base station configured to receive a command message from a user terminal, receive information responding to the command message from the one or more wireless sensor nodes and/or the wired network, and send a state message or a data message to the user terminal based on the received information.

### BRIEF DESCRIPTION OF THE DRAWINGS

FIG. 1 is a diagram conceptually showing communication between a vehicle network system and a user terminal according to an embodiment of the present disclosure;

FIG. 2 is a diagram showing the format of an overall message delivered between a base station and a user terminal according to an embodiment of the present disclosure;

FIG. 3 is a diagram showing the format of a command message;

FIG. 4 is a diagram showing the format of a state message;

FIG. 5 is a diagram showing the format of an Acknowledgement (ACK) message;

FIG. 6 is a diagram showing the format of a data message;

FIGS. 7 and 8 are diagrams showing a procedure for monitoring the overall sensor information of all vehicle wireless sensor nodes or overall vehicle information;

FIGS. 9 and 10 are diagrams showing a procedure for monitoring the sensor information of an individual vehicle wireless sensor node or individual vehicle information;

FIG. 11 is a diagram showing a procedure for monitoring the event-based sensor information of a vehicle wireless sensor node or event-based vehicle information;

FIG. 12 is a diagram showing a procedure for delivering the overall state information of all vehicle wireless sensor nodes in response to the request of a user terminal;

FIG. 13 is a diagram showing a procedure for delivering the state information of an individual vehicle wireless sensor node in response to the request of the user terminal;

FIG. 14 is a diagram showing a procedure for delivering the state information of an in-vehicle wired network in response to the request of the user terminal;

FIG. 15 is a diagram showing a procedure for delivering the event-based state information of a vehicle wireless sensor node when an abnormality occurs in the vehicle wireless sensor node; and

FIG. 16 is a diagram showing a procedure for delivering the event-based state information of an in-vehicle wired network when an abnormality occurs in the in-vehicle wired network.

### DETAILED DESCRIPTION

The above-described objects, features, and advantages are described in detail with reference to the accompanying drawings in order to describe the present disclosure in detail so that those having ordinary knowledge in the technical field to which the present disclosure pertains can easily practice the present disclosure. In the following description of the present disclosure, detailed descriptions of known functions and configurations which are deemed to make the gist of the present disclosure obscure will be omitted. Hereinafter, exemplary embodiments of the present disclosure will be described in detail with reference to the attached drawings.

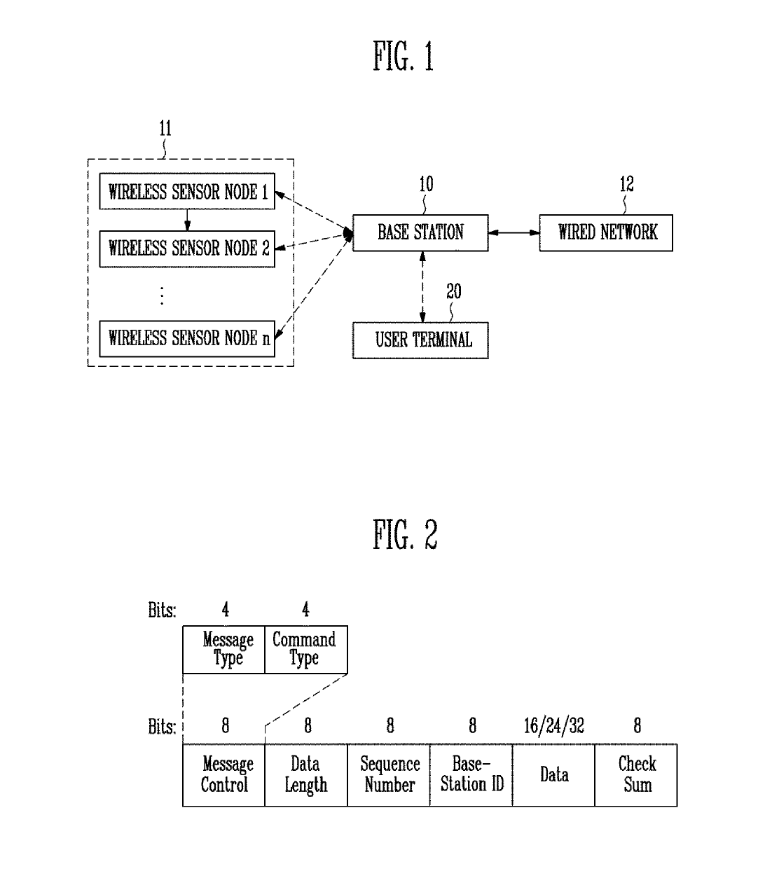

FIG. 1 is a diagram conceptually showing communication between a vehicle network system and a user terminal according to an embodiment of the present disclosure.

Referring to FIG. 1, the vehicle network system according to an embodiment of the present disclosure may include a base station 10, one or more wireless sensor nodes 11 installed inside and/or outside of a vehicle, and a wired network 12 installed inside of the vehicle.

The base station 10 sends an operation command to the wireless sensor nodes 11 arranged at any locations of the inside/outside of the vehicle, and analyzes and processes sensor information, transmitted from the wireless sensor nodes 11 in compliance with the operation command, in real time. Further, the base station 10 receives vehicle information from the communication terminal of the wired network 12 arranged in the vehicle and processes the vehicle information. Furthermore, the base station transmits the information of the wireless sensor nodes and vehicle information to a user terminal 20, such as a smart phone or a navigation device, in real time through a wireless network interface such as for Bluetooth in compliance with the command of the user terminal 20.

The functions of protocol communication between the base station 10 and the user terminal 20 are defined as follows.
Request and response for state information of vehicle wireless sensor node
Request and response for event-based state information of vehicle wireless sensor node
Request and response for sensor information of vehicle wireless sensor node
Request and response for event-based sensor information of vehicle wireless sensor node
Request and response for vehicle information
Request and response for event-based vehicle information
Request and response for state information of in-vehicle wired network
Request and response for event-based state information of in-vehicle wired network

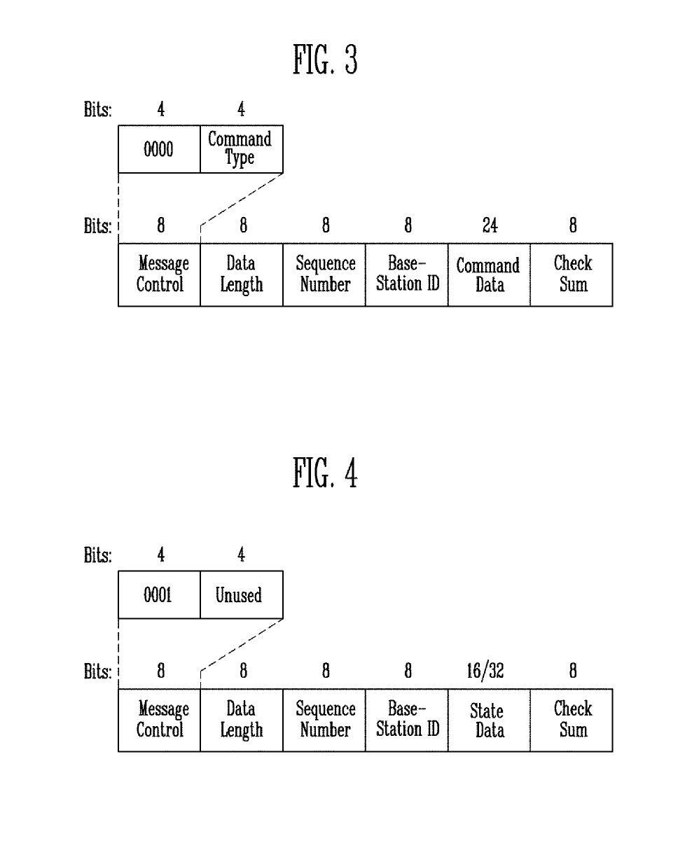

FIG. 2 is a diagram showing the format of an overall message that is delivered between a base station and a user terminal according to an embodiment of present disclosure.

Referring to FIG. 2, the format of the overall message delivered between the base station and the user terminal is divided into six fields (i.e. “Message Control”, “Data Length”, “Sequence Number”, “Base-Station ID”, “Data”, and “Check Sum”). The messages between the base station and the user terminal may have different lengths according to the message type, wherein the length of “Data” may vary according to the message type, but all messages that are sent or received conform to a defined format.

As shown in Table 1, the Message Control field is composed of 8 bits, and is subdivided into a Message Type sub-field and a Command Type sub-field as detailed components, as shown in Table 2.

TABLE 1

| | | Length | |
|---|---|---|---|
| Field name | Type | (bits) | Description |
| Message Control | Unsigned char | 8 | Message Type (4 bits) |
| | | | Command Type (4 bits) |

TABLE 2

| | | | Based on user terminal | |
|---|---|---|---|---|
| Type | Value | Description | TX | RX |
| Command | 0000 | Command message | ◯ | |
| State | 0001 | State message | | ◯ |
| Ack | 0010 | Acknowledgement | ◯ | ◯ |
| | | (ACK) message | | |
| Data | 0011 | Data message | | ◯ |
| — | 0100~1111 | Reserved | | |

The Message Type sub-field is used to define the types of respective messages. The Message Type sub-field has a length of 4 bits and is set to any one of the values defined in Table 2.

The Command Type sub-field is used to define the types of respective Command messages (see FIG. 5). The Command Type sub-field has a length of 4 bits.

The Data Length field is composed of 8 bits and indicates the length of the Sequence Number, Base-Station ID, and Data included in the overall message format.

As shown in the following Table 3, the Sequence Number field is composed of 8 bits and defines the Sequence ID of messages. Further, the Sequence Number field defines a Data Sequence Number (DSN) used to match an ACK message with a Data message, an ACK message with a State message, and an ACK message with a Command message.

TABLE 3

| Field name | Type | Length (bits) | Description |
|---|---|---|---|
| Sequence Number | Unsigned char | 8 | Message serial number |

As shown in the following Table 4, a Base-Station ID field is composed of 8 bits and is used to distinguish multiple base stations from each other when multiple base stations are arranged in the vehicle. Further, all base stations in the same vehicle have unique identifiers.

TABLE 4

| | | Length | |
|---|---|---|---|
| Field name | Type | (bits) | Description |
| Base-Station ID | Unsigned char | 8 | Identifier of base station |

The Data field is used to have different fixed lengths depending on the types of messages and is implemented to have a length of 16 bits, 24 bits, or 32 bits. Data transmitted from the base station to the user terminal includes the sensor information of vehicle wireless sensor nodes, the state information of the vehicle wireless sensor nodes, vehicle information, the state information of the in-vehicle wired network, etc. Further, data transmitted from the user terminal to the base station includes settings based on commands. The Check Sum field is composed of 8 bits and is used to check whether each message is normal. The Check Sum field indicates a value obtained by performing an Exclusive OR (XOR) operation on the respective bytes of the fields ranging from the Message Control field to the Data field.

FIG. 3 is a diagram showing the format of a Command message.

Referring to FIG. 3, the user terminal delivers commands, such as a request for the sensor information of vehicle wireless sensor nodes, a request for the state information of the vehicle wireless sensor nodes, a vehicle information request, and a request for the state information of an in-vehicle wired network, to the base station, via the Command message. In order to use a certain message as a Command message, the Message Type sub-field of the Message Control field is set to “0000”. The Command Type sub-field is composed of 4 bits and is used to distinguish commands transmitted from the user terminal to the base station from each other. The Command Type sub-field is set to one of the values defined in the following Table 5.

TABLE 5

| Command | | |
|---|---|---|
| ID | Name | Description |
| 0001 | Request_SenState_Evt | Request for event-based state information of |
| | | vehicle wireless sensor node |
| | | information is requested depending on |
| | | SensorNode_ID (see Command Data field) |
| 0010 | Request_SenInfo | Request for sensor information of vehicle |
| | | wireless sensor nodes |
| | | information is requested depending on |
| | | SensorNode_ID |
| | | when Time_Interval is “0”, request is |
| | | transmitted only once |
| | | when Time_Interval is a value other than “0”, |
| | | request is periodically transmitted at preset |
| | | transmission time intervals (see Command Data |
| | | field) |
| 0011 | Request_SenInfo_Evt | Request for event-based sensor information of |
| | | vehicle wireless sensor node |
| | | information is requested depending on |
| | | SensorNode_ID (see Command Data field) |
| 0100 | Request_VehicleInfo | Vehicle information request |
| | | information is requested depending on |
| | | VehicleInfo_ID |
| | | when Time_Interval is “0”, request is |
| | | transmitted only once |
| | | when Time_Interval is a value other than “0”, |
| | | request is periodically transmitted at preset |
| | | transmission time intervals (see Command Data |
| | | field) |
| 0101 | Request_VehicleInfo_Evt | Request for event-based vehicle information |
| | | information is requested depending on |
| | | VehicleInfo_ID (see Command Data field) |
| 0110 | Request_VehicleState | Request for state information of in-vehicle wired |
| | | network |
| 0111 | Request_VehicleState_Evt | Request for event-based state information of in- |
| | | vehicle wired network |
| 1000~1111 | — | Reserved |

The Command Data field is composed of 24 bits, as shown in the following Table 6. When it is desired to receive the sensor information of the vehicle wireless sensor nodes from the base station, the Command Data field includes the identifier of the corresponding vehicle wireless sensor node, whereas it is desired to receive vehicle information, the Command Data field includes the identifier of the corresponding vehicle information. Further, the Command Data field includes the value of Time_Interval, which means an interval between transmission times at which the base station transmits information to the user terminal.

TABLE 6

| | | Length | |
|---|---|---|---|
| Name | Type | (bits) | Description |
| SensorNode_ID/ | unsigned char | 8 | Identifier (ID) of vehicle wireless sensor |
| VehicleInfo_ID | | | node or vehicle information, for which |
| | | | the user terminal desires to receive |
| | | | information from the base station |
| | | | (0xFF: request for overall sensor |
| | | | information of all vehicle wireless sensor |
| | | | nodes or for overall vehicle information) |
| | | | This value is “Unused” when request for |
| | | | state information of in-vehicle wired |
| | | | network or request for event-based state |
| | | | information of in-vehicle wired network is |
| | | | made |
| Time_Interval | unsigned short | 16 | Interval between transmission times of |
| | | | information by the base station(unit: ms) |
| | | | This value is “Unused” when request for |
| | | | state information of vehicle wireless sensor |
| | | | nodes, request for event-based state |
| | | | information of vehicle wireless sensor |
| | | | node, request for event-based sensor |
| | | | information of vehicle wireless sensor |
| | | | node, request for event-based vehicle |
| | | | information, request for state information |
| | | | of in-vehicle wired network, or request for |
| | | | event-based state information of in-vehicle |
| | | | wired network is made |

FIG. 4 is a diagram showing the format of a State message.

Referring to FIG. 4, the State message is used by the base station to transmit the state information of vehicle wireless sensor nodes and the state information of an in-vehicle wired network to the user terminal. In order to use a certain message as a State message, the Message Type sub-field of the Message Control field is set to “0001”.
In response to the command of the user terminal, the base station delivers the state information of the vehicle wireless sensor nodes or the state information of the in-vehicle wired network.
When various types of abnormalities occur in the vehicle wireless sensor nodes or the in-vehicle wired network, the base station delivers abnormal state information to the user terminal.

The State Data field of the vehicle wireless sensor nodes is transmitted, with the state information shown in Table 7 being included in the State Data field.

TABLE 7

| Name | Type | Length (bits) | Description |
|---|---|---|---|
| Sensor Type | unsigned char | 8 | This indicates state information of |
| | | | vehicle wireless sensor nodes |
| | | | 0x01(00000001) |
| SensorNode_ID | unsigned char | 8 | Identifier of each vehicle wireless |
| | | | sensor node, for which the user |
| | | | terminal desires to receive |
| | | | information from the base station |
| SW_VER | unsigned char | 8 | Software version information |
| ERROR_CODE | unsigned char | 8 | Error code of vehicle wireless sensor |
| | | | node |

The State Data field of the in-vehicle wired network is transmitted, with the state information shown in Table 8 being included in the State Data field.

TABLE 8

| | | Length | |
|---|---|---|---|
| Name | Type | (bits) | Description |
| Vehicle Type | unsigned | 8 | This indicates state information of |
| | char | | in-vehicle wired network |
| | | | 0x02(00000010) |
| State | unsigned | 8 | 0x00: Normal |
| | char | | 0x01: Abnormal |

FIG. 5 is a diagram showing the format of an ACK message.

Referring to FIG. 5, the ACK message includes “Message Control”, “Sequence Number”, and “Check Sum” fields. In order to use a certain message as an ACK message, the Message Type sub-field of the Message Control field is set to “0010”.

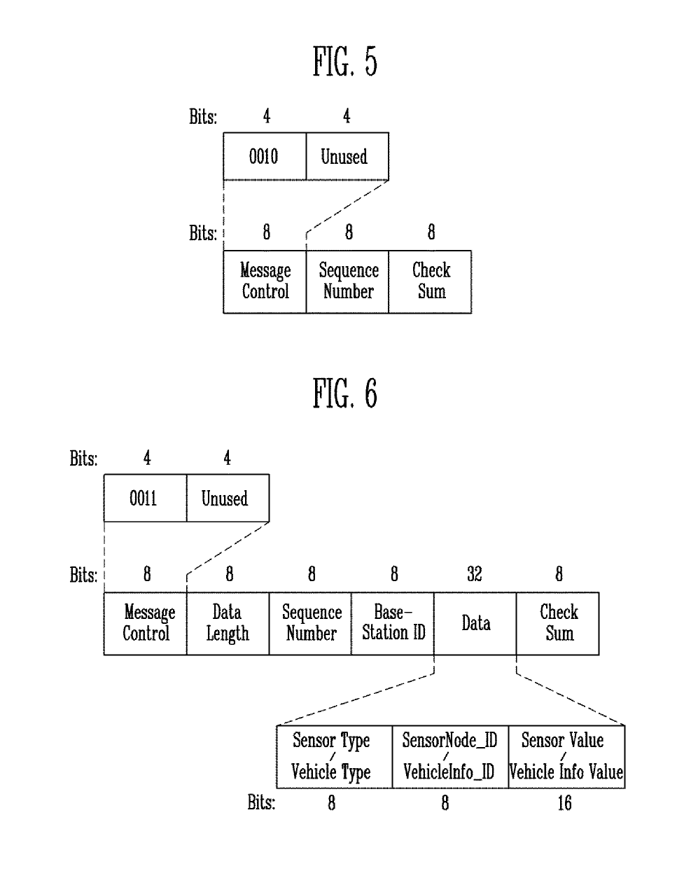

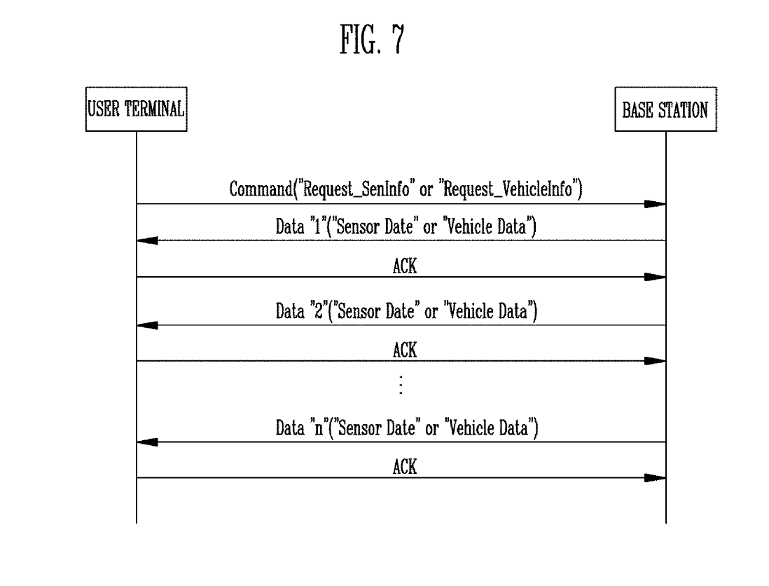

FIG. 6 is a diagram showing the format of a Data message.

Referring to FIG. 6, the Data message is used to deliver the sensor information of vehicle wireless sensor nodes and vehicle information to the user terminal. The Data field of the Data message has a fixed length, which is composed of 32 bits. More specifically, the Data field includes an 8-bit identifier field for identifying the type of sensor information of each vehicle wireless sensor node or the type of vehicle information, an 8-bit identifier field for identifying the ID of each vehicle wireless sensor node or the ID of vehicle information, and a 16-bit field indicating the 16-bit value of the sensor information of each vehicle wireless sensor node or the vehicle information. In order to use a certain message as a Data message, the Message Type sub-field of the Message Control field is set to “0011”.

The Data field of the Data message is configured, as shown in the following Table 9.

TABLE 9

| | | Length | |
|---|---|---|---|
| Name | Type | (bits) | Description |
| Sensor Type/ | unsigned | 8 | This indicates sensor |
| Vehicle Type | char | | information of each vehicle |
| | | | wireless sensor node: |
| | | | 0x01(00000001) |
| | | | This indicates vehicle |
| | | | information: 0x02(00000010) |
| SensorNode_ID/ | unsigned | 8 | Identifier of each vehicle |
| VehicleInfo_ID | char | | wireless sensor node |
| | | | identifier of vehicle information |
| Sensor Value/ | unsigned | 16 | Sensor information value of each |
| Vehicle Info | short | | vehicle wireless sensor node |
| Value | | | Vehicle information value |

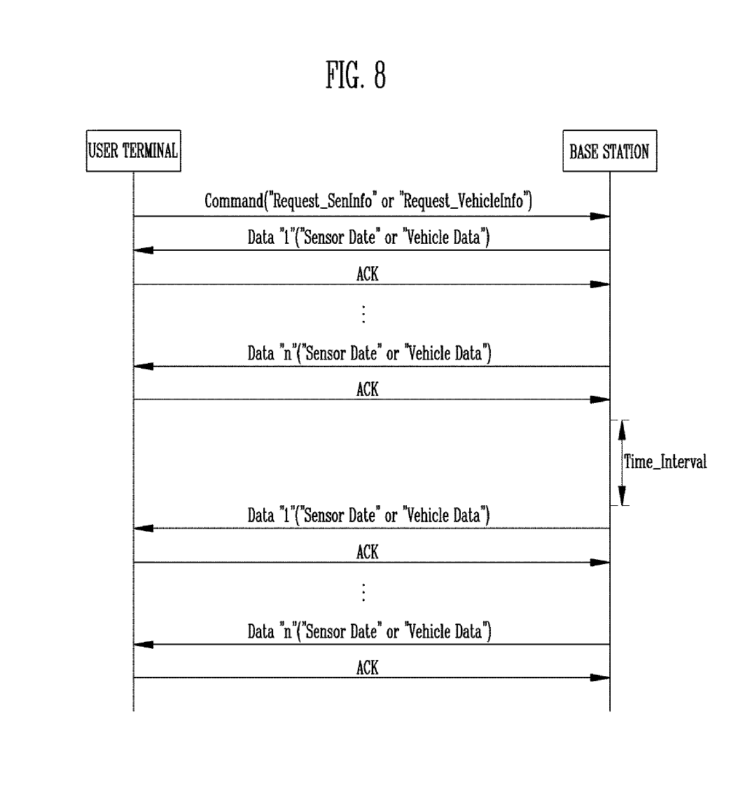

FIGS. 7 to 16 are flow diagrams showing a procedure for delivering messages between the user terminal and the base station according to an embodiment of the present disclosure.

Hereinafter, a message delivery procedure required for the case where the user terminal receives, from the base station, the sensor information of each vehicle wireless sensor node, the state information of the vehicle wireless sensor node, the state information of the in-vehicle wired network, or vehicle information will be described in detail with reference to FIGS. 7 to 16.

The procedure in which the user terminal collects the sensor information of each vehicle wireless sensor node or the vehicle information via the base station is performed using one of the following methods.
Monitoring of overall sensor information of all vehicle wireless sensor nodes or overall vehicle information
Monitoring of sensor information of individual vehicle wireless sensor node or individual vehicle information
Monitoring of event-based sensor information of vehicle wireless sensor node or event-based vehicle information

FIGS. 7 and 8 are flow diagrams showing a procedure for monitoring the overall sensor information of all vehicle wireless sensor nodes or the overall vehicle information.

The user terminal may request the overall sensor information of all vehicle wireless sensor nodes or the overall vehicle information, which is acquired by the base station, via the Command message. Here, depending on the value of Time_Interval set in the Command Data field, the overall sensor information of all vehicle wireless sensor nodes or the overall vehicle information may be received only once or may be periodically received at specific time intervals.

The procedure for monitoring the overall sensor information of all vehicle wireless sensor nodes or the overall vehicle information is described below.

In order to send a Command message required to request the overall sensor information of all vehicle wireless sensor nodes or the overall vehicle information, the user terminal sets the Message Type sub-field of the Message Control field to “0000”, and sets the Command Type sub-field as follows.
Request for sensor information of vehicle wireless sensor nodes: “0010”
Request for vehicle information: “0100”

Further, the user terminal sends the Command message after setting the sensor node ID or the vehicle information ID of the Command Data field to 0xFF.

The base station sequentially transmits acquired overall sensor information of all vehicle wireless sensor nodes or acquired overall vehicle information to the user terminal.

The user terminal receives pieces of sensor information of respective vehicle wireless sensor nodes or respective pieces of vehicle information, and then sends ACK messages corresponding to the pieces of sensor information or the pieces of vehicle information.

After transmitting the overall sensor information of all vehicle wireless sensor nodes or the overall vehicle information, the base station terminates transmission if the value of Time Interval set in the Command Data field of the Command message is set to ‘0’, and repeats a procedure for transmitting new data at specific time intervals and waiting for an ACK message to be received if the value of Time_Interval is set to a specific time.

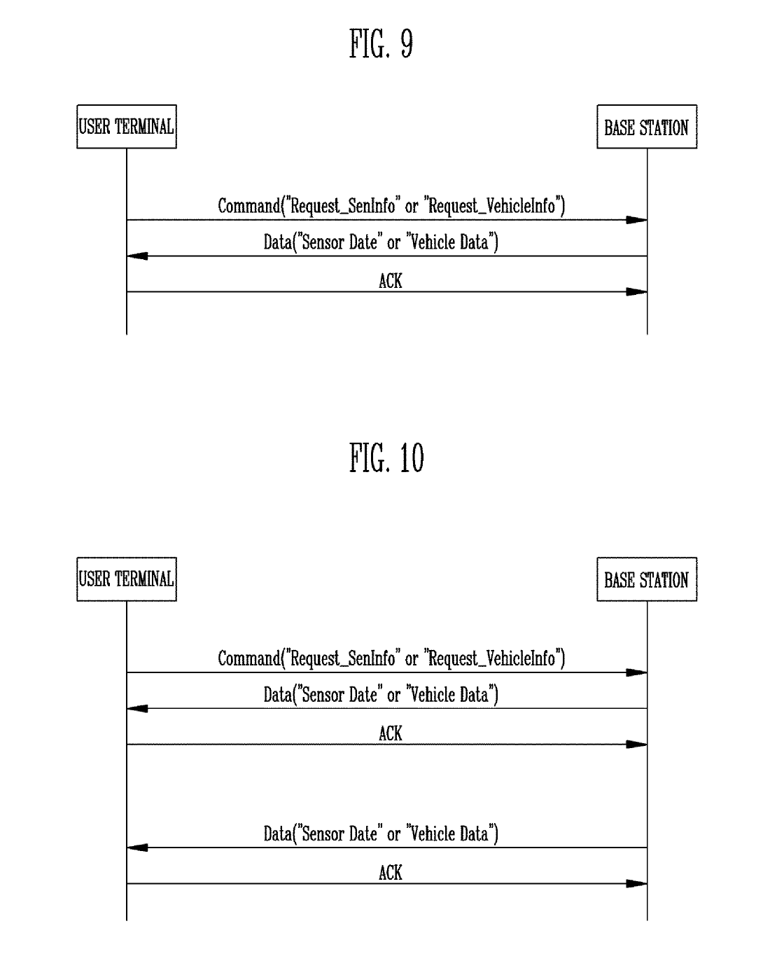

FIGS. 9 and 10 are flow diagrams showing a procedure for monitoring the sensor information of an individual vehicle wireless sensor node or individual vehicle information.

The user terminal may request the sensor information of an individual vehicle wireless sensor node or individual vehicle information, which is acquired by the base station, via a Command message. Here, depending on the value of Time_Interval set in the Command Data field, the sensor information of an individual vehicle wireless sensor node or the individual vehicle information may be received only once or may be periodically received at specific time intervals.

The procedure for monitoring the sensor information of the individual vehicle wireless sensor node or the individual vehicle information is described below.

In order to send a Command message required to request the sensor information of the individual vehicle wireless sensor node or the individual vehicle information, the user terminal sets the Message Type sub-field of the Message Control field to “0000”, and sets the Command Type sub-field as follows.
Request for sensor information of vehicle wireless sensor node: “0010”
Request for vehicle information: “0100”

Further, the user terminal sends the Command message after setting the sensor node ID or the vehicle information ID of the Command Data field to the ID of the individual vehicle wireless sensor node that is desired to be monitored or the ID of the individual vehicle information that is desired to be monitored.

The base station transmits the acquired sensor information of the individual vehicle wireless sensor node or the acquired individual vehicle information to the user terminal.

The user terminal receives the sensor information of the individual vehicle wireless sensor node or the individual vehicle information, and then sends an ACK message corresponding to the sensor information of the individual vehicle wireless sensor node or the individual vehicle information.

After transmitting the sensor information of the individual vehicle wireless sensor node or the individual vehicle information, the base station terminates transmission if the value of Time Interval set in the Command Data field of the Command message is set to ‘0’, and repeats a procedure for transmitting new data at specific time intervals and waiting for an ACK message to be received if the value of Time_Interval is set to a specific time.

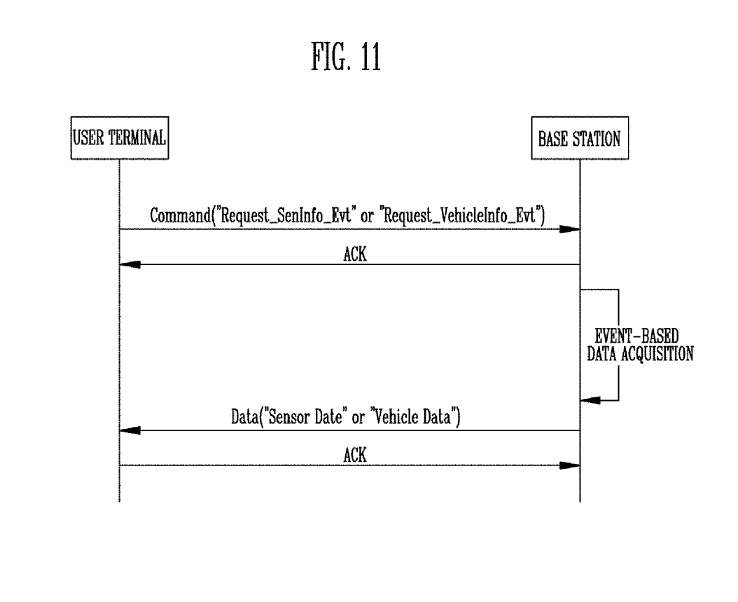

FIG. 11 is a flow diagram showing a procedure for monitoring the event-based sensor information of a vehicle wireless sensor node or event-based vehicle information.

The user terminal may request event-based sensor information of a vehicle wireless sensor node or event-based vehicle information, which is acquired by the base station, via a Command message. Here, if a Command message is sent only once, the user terminal may receive the event-based sensor information of the wireless sensor node or the event-based vehicle information, which is acquired by the base station, without making a request again.

The procedure for monitoring the event-based sensor information of the vehicle wireless sensor node or the event-based vehicle information is described below.

In order to send a Command message required to request the event-based sensor information of the vehicle wireless sensor node or the event-based vehicle information, the user terminal sets the Message Type sub-field of the Message Control field to “0000” and sets the Command Type sub-field as follows.
Request for event-based sensor information of vehicle wireless sensor node: “0011”
Request for event-based vehicle information: “0101”

Further, the user terminal sends the Command message to the base station after setting the sensor node ID or the vehicle information ID of the Command Data field to 0xFF when it is desired to monitor the event-based overall sensor information of all vehicle wireless sensor nodes or event-based overall vehicle information, and setting the sensor node ID or the vehicle information ID of the Command Data field to the ID of an individual vehicle wireless sensor node or the ID of individual vehicle information when it is desired to monitor the event-based sensor information of an individual vehicle wireless sensor node or event-based individual vehicle information.

When a monitoring request for event-based sensor information of all vehicle wireless sensor nodes or an individual vehicle wireless sensor node or a monitoring request for event-based overall or individual vehicle information is received from the user terminal, the base station sends an ACK message to the user terminal.

The user terminal waits for the event-based sensor information of a vehicle wireless sensor node or event-based vehicle information to be received.

The base station transmits the acquired event-based sensor information of the vehicle wireless sensor node or the event-based vehicle information to the user terminal.

After receiving the event-based sensor information of the vehicle wireless sensor node or the event-based vehicle information, the user terminal sends an ACK message.

After sending the ACK message, the user terminal waits for event-based sensor information of a vehicle wireless sensor node or event-based vehicle information to occur.

The procedure by which the user terminal collects the state information of each vehicle wireless sensor node or the state information of the in-vehicle wired network via the base station is implemented using one of the following methods.
Delivery of state information of each vehicle wireless sensor node performed in response to the request of the user terminal
Delivery of state information of the in-vehicle wired network performed in response to the request of the user terminal
Delivery of event-based state information of a vehicle wireless sensor node performed when an abnormality occurs in the vehicle wireless sensor node
Delivery of event-based state information of the in-vehicle wired network performed when an abnormality occurs in the in-vehicle wired network

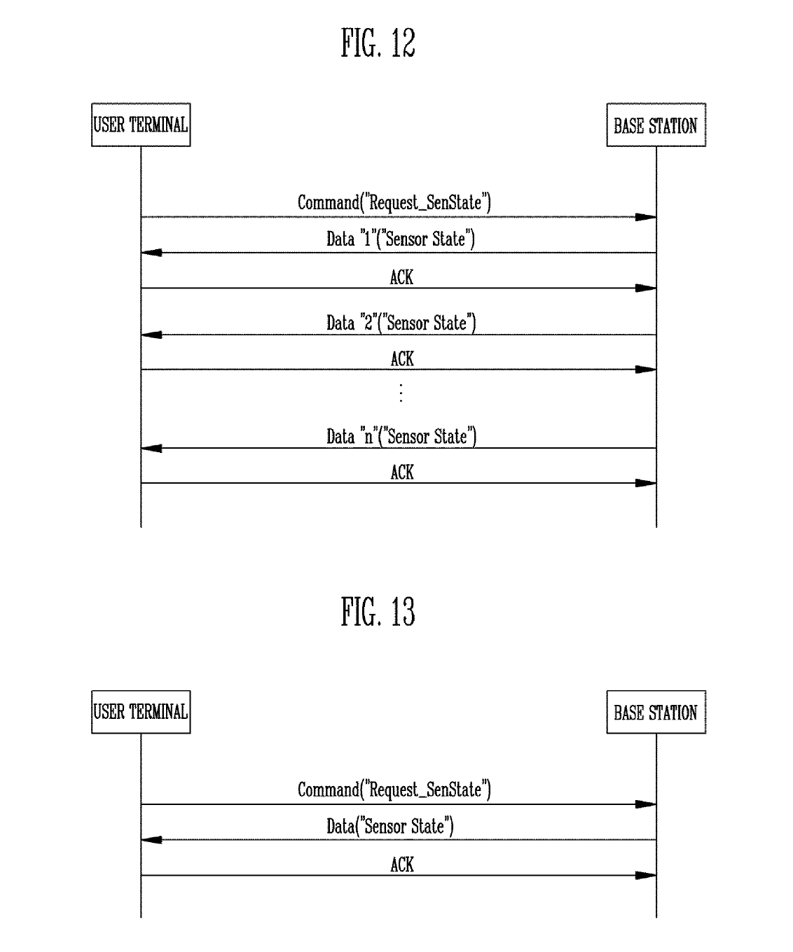

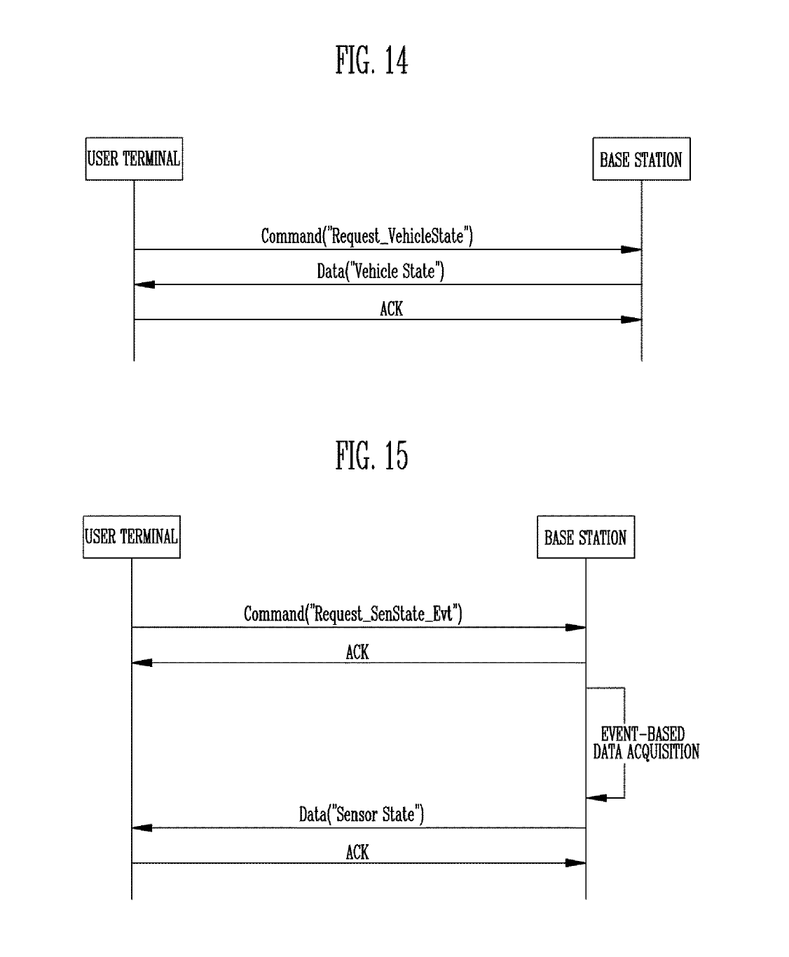

FIG. 12 is a flow diagram showing a procedure for delivering overall state information of all vehicle wireless sensor nodes in response to the request of the user terminal, and FIG. 13 is a flow diagram showing a procedure for delivering the state information of an individual vehicle wireless sensor node in response to the request of the user terminal.

The user terminal may request the state information of each vehicle wireless sensor node, which is acquired by the base station, via a Command message.

The procedure for delivering the state information of each vehicle wireless sensor node in response to the request of the user terminal is described below.

To send a Command message required to request the state information of all vehicle wireless sensor nodes or an individual vehicle wireless sensor node, the user terminal sets the Message Type sub-field of the Message Control field to “0000” and sets the Command Type sub-field to “0000”.

Further, the user terminal sends the Command message after setting the sensor node ID of the Command Data field to either the ID of an individual vehicle wireless sensor node that is desired to be monitored or 0xFF.

The base station transmits the acquired state information of all vehicle wireless sensor nodes or an individual vehicle wireless sensor node to the user terminal.

After receiving pieces of state information of respective vehicle wireless sensor nodes, the user terminal sends ACK messages corresponding to the pieces of state information of respective vehicle wireless sensor nodes.

When receiving respective ACK messages after pieces of state information of respective vehicle wireless sensor nodes have been transmitted, the base station terminates the procedure for delivering the state information of vehicle wireless sensor nodes in response to the request of the user terminal.

FIG. 14 is a flow diagram showing a procedure for delivering the state information of the in-vehicle wired network in response to the request of the user terminal.

The user terminal may request the state information of the in-vehicle wired network, which is acquired by the base station, via a Command message.

The procedure for delivering the state information of the in-vehicle wired network in response to the request of the user terminal will be described below.

To send a Command message required to request the state information of the in-vehicle wired network, the user terminal send the Command message after setting the Message Type sub-field of the Message Control field to “0000”, and setting the Command Type sub-field to “0110”.

The base station transmits the acquired state information of the in-vehicle wired network to the user terminal.

After receiving the state information of the in-vehicle wired network, the user terminal sends an ACK message corresponding to the state information of the in-vehicle wired network.

When receiving the ACK message after the state information of the in-vehicle wired network has been transmitted, the base station terminates the procedure for delivering the state information of the in-vehicle wired network in response to the request of the user terminal.

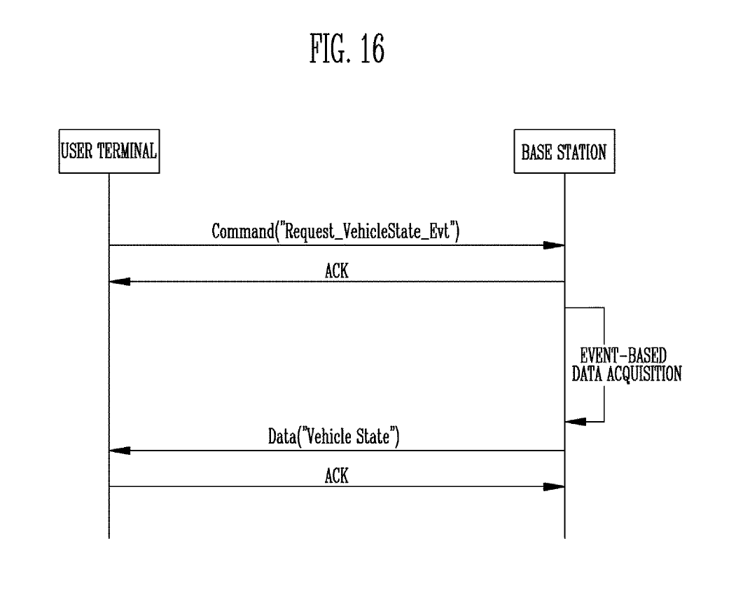

FIG. 15 is a flow diagram showing a procedure for delivering event-based state information of a vehicle wireless sensor node when an abnormality occurs in the vehicle wireless sensor node.

The user terminal may request the event-based state information of a vehicle wireless sensor node, which is acquired by the base station when an abnormality occurs in the vehicle wireless sensor node, via the Command message. Here, the user terminal may receive the event-based state information of the vehicle wireless sensor node, acquired by the base station, without making a request again if the Command message is sent only once.

The procedure for monitoring the event-based state information of a vehicle wireless sensor node when an abnormality occurs in the vehicle wireless sensor node is described below.

To send a command message required to request the event-based state information of all vehicle wireless sensor nodes or an individual vehicle wireless sensor node, the user terminal sets the Message Type sub-field of the Message Control field to “0000” and sets the Command Type sub-field to “0001”.

Further, the user terminal sends the Command message after setting the sensor node ID of the Command Data field to the ID of an individual vehicle wireless sensor node that is desired to be monitored or to ‘0xFF’.

After receiving a request command for event-based state information of all vehicle wireless sensor nodes or an individual vehicle wireless sensor node from the user terminal, the base station sends an ACK message.

The user terminal waits for the event-based state information of a vehicle wireless sensor node to be received.

The base station transmits the acquired event-based state information of the vehicle wireless sensor node to the user terminal.

After receiving the event-based state information of the vehicle wireless sensor node, the user terminal sends an ACK message corresponding to the state information of the vehicle wireless sensor node.

After sending the ACK message, the user terminal waits for the event-based state information of a vehicle wireless sensor node to occur.

FIG. 16 is a flow diagram showing a procedure for delivering the event-based state information of an in-vehicle wired network when an abnormality occurs in the in-vehicle wired network.

The user terminal may request the event-based state information of an in-vehicle wired network, which is acquired by the base station when an abnormality occurs in the in-vehicle wired network, via a Command message. In this case, the user terminal may receive the event-based state information of the in-vehicle wired network, acquired by the base station, without making a request again if the Command message is sent only once.

The procedure for monitoring the event-based state information of the in-vehicle wired network when an abnormality occurs in the in-vehicle wired network will be described below.

To send a Command message required to request the event-based state information of the in-vehicle wired network, the user terminal sends the Command message after setting the Message Type sub-field of the Message Control field to “0000” and setting the command Type sub-field to “0111”.

When receiving a request command for event-based state information of the in-vehicle wired network from the user terminal, the base station sends an ACK message.

The user terminal waits for the event-based state information of the in-vehicle wired network to be received.

The base station transmits the acquired event-based state information of the in-vehicle wired network to the user terminal.

After receiving the event-based state information of the in-vehicle wired network, the user terminal sends an ACK message corresponding to the event-based based state information of the in-vehicle wired network.

After sending the ACK message, the user terminal waits for the event-based state information of the in-vehicle wired network to occur.

In accordance with the present disclosure, a user terminal may operate in conjunction with a base station that is the component of an in-vehicle wireless sensor network system, and may acquire sensor information present inside/outside of a vehicle and vehicle information from the base station, thus providing various services to drivers.

Although the technical spirit of the present disclosure has been described in detail with reference to exemplary embodiments, it should be noted that those embodiments are intended to merely describe the invention and are not intended to restrict the invention. Further, those skilled in the art will appreciate that various modifications, additions and substitutions are possible, without departing from the scope and spirit of the invention as disclosed in the accompanying claims.

What is claimed is:

1. A protocol communication method for a vehicle network system, the method being configured such that a base station installed in a vehicle communicates with a user terminal, comprising:
receiving, by the base station, a command message from the user terminal;
receiving, by the base station, information responding to the command message from one or more vehicle wireless sensor nodes and/or an in-vehicle wired network; and
sending, by the base station, a state message to the user terminal, based on the received information.

2. The protocol communication method of claim 1, wherein:
the command message and the state message include in common a control field and a data field, and
the control field includes a message type sub-field and a control type sub-field.

3. The protocol communication method of claim 2, wherein the command message is configured such that:
the message type sub-field of the control field is fixed at a first value, and
a type of command is determined depending on a value of the control type sub-field.

4. The protocol communication method of claim 2, wherein the state message is configured such that:
the message type sub-field of the control field is fixed at a second value, and
the data field includes state information of the one or more wireless sensor nodes and/or state information of the wired network.

5. A protocol communication method for a vehicle network system, the method being configured such that a base station installed in a vehicle communicates with a user terminal, comprising:
receiving, by the base station, a command message from the user terminal;
receiving, by the base station, information responding to the command message from one or more vehicle wireless sensor nodes and/or an in-vehicle wired network; and
sending, by the base station, a data message to the user terminal, based on the received information.

6. The protocol communication method of claim 5, wherein:
the command message and the data message include in common a control field and a data field, and
the control field includes a message type sub-field and a control type sub-field.

7. The protocol communication method of claim 6, wherein the command message is configured such that:
the message type sub-field of the control field is fixed at a first value, and
a type of command is determined depending on a value of the control type sub-field.

8. The protocol communication method of claim 6, wherein the data message is configured such that:
the message type sub-field of the control field is fixed at a third value, and
the data field includes sensor information of the one or more wireless sensor nodes and/or vehicle information.

9. A vehicle network system, comprising:
one or more wireless sensor nodes installed inside and/or outside of a vehicle;
a wired network installed inside of the vehicle; and
a base station configured to receive a command message from a user terminal, receive information responding to the command message from the one or more wireless sensor nodes and/or the wired network, and send a state message or a data message to the user terminal based on the received information.

10. The vehicle network system of claim 9, wherein:
the command message, the state message, and the data message include in common a control field and a data field, and
the control field includes a message type sub-field and a control type sub-field.

11. The vehicle network system of claim 10, wherein the command message is configured such that:
the message type sub-field of the control field is fixed at a first value, and
a type of command is determined depending on a value of the control type sub-field.

12. The vehicle network system of claim 10, wherein the state message is configured such that:
the message type sub-field of the control field is fixed at a second value, and
the data field includes state information of the one or more wireless sensor nodes and/or state information of the wired network.

13. The vehicle network system of claim 10, wherein the data message is configured such that:
the message type sub-field of the control field is fixed at a third value, and
the data field includes sensor information of the one or more wireless sensor nodes and/or vehicle information.
